(19) United States
(12) Patent Application Publication
(10) Pub. No.: US 2003/0005428 A1
(43) Pub. Date: Jan. 2, 2003

(54) Global media exchange

(76) Inventor: Kendyl A. Roman, Sunnyvale, CA (US)

Correspondence Address: Kendyl A. Roman, 730 Bantry Court, Sunnyvale, CA, 94087-3402, US

(21) Appl. No.: 10/154,775

(22) Filed: May 24, 2002

Related U.S. Application Data
(60) Provisional application No. 60/293,772, filed on May 26, 2001.

(51) Int. Cl. H04N 7/16; H04N 7/173

(52) U.S. Cl. 725/1; 725/104; 725/87; 725/101

(57) ABSTRACT

A system and methods of providing a globally accessible media exchange, whereby media creators, media rights holders, and agents can offer media and media rights to a world-wide market. Media users and publishers can find and preview the media that they need or want and purchase media ownership or license media rights through the media exchange. The media exchange can store digital graphics, audio, and video. The media exchange can also manage the transfer of media and media rights for physical media. In some embodiments, the media exchange can establish a dynamic fair market value based on matching asking prices and bids. Some embodiments could be limited to a single media type such as just audio media.

### RELATED APPLICATIONS

This application claims priority under 35 U.S.C. § 199(e) of the co-pending U.S. patent application Ser. No. 09/312,922, filed on May 17, 1999 and entitled “SYSTEM FOR TRANSMITTING VIDEO IMAGES OVER A COMPUTER NETWORK TO A REMOTE RECEIVER”, which claims a priority date based on provisional application serial No. 60/085,818, filed May 18, 1998 entitled “APPARATUS FOR TRANSMITTING LIVE VIDEO IMAGES OVER A COMPUTER NETWORK TO MULTIPLE RECEIVERS”, the subject matter of which is incorporated herein by reference. Said application is wholly owned by the present inventor and shares common inventorship.

This application claims priority under 35 U.S.C. § 199(e) of the co-pending U.S. patent application Ser. No. 09/467,721, filed on Dec. 20, 1999 and entitled “VARIABLE GENERAL PURPOSE COMPRESSION FOR VIDEO IMAGES (ZLN)”, which claims a priority date based on U.S. provisional application 60/113,051, filed on Dec. 21, 1998 the subject matter of which is incorporated herein by reference.

This application claims priority under 35 U.S.C. § 199(e) of the co-pending U.S. provisional application serial No. 60/293,772, filed May 26, 2001 entitled “GLOBAL MEDIA ARCHIVE”. The provisional application serial No. 60/293,772, filed May 26, 2001 entitled “GLOBAL MEDIA ARCHIVE” is also hereby incorporated by reference.

### BACKGROUND—FIELD OF THE INVENTION

This invention relates to media exchange, specifically to use of a computer based media archive and electronic market for exchanging media rights and copies of the media based on those rights.

### BACKGROUND

Physical Media

Through out time, man has created and recorded images and sounds in various media. These images and sounds add value to the media because they communicate either information or aesthetic beauty. Examples of physical media include cave wall hieroglyphics, stone tablets, metal plates, papyrus scrolls, parchment, ink on paper, paint on canvas, photographic film, printed photographs, motion picture film, phonograph records, audio tapes, compact diskettes, video tapes, DVDs, sculptures, and other pieces of fine art.

Because the ideas and expressions contained on physical media have value, people and governments have provided protection of the content of the media through patents, copyrights, and tradesecret rights.

Digital Media

With the development of computers and related technology the informational and aesthetic content of physical medical can be captured and stored in electronically readable digital format. The physical characteristics of color, light and sound are measured and the measurements are stored as numbers. The numbers that represent the physical characteristics of the content (ideas and expression) are stored electronically in digital media. Examples of digital media are files stored on a computer hard disk, CD-ROM, DVD, magnetic tape, floppy diskette; data stored in a computer memory; or data being transferred over a computer network.

Content can be created directly in digital form. For example, digital artists can create images using computers to draw or calculate components of the image. Engineers and architects use computers to create drawings, schematics, and blue prints. Movies and music can also be created using computers or other electronics.

Media Conversion

Regardless of whether media content is created in a physical or digital form, all media can be represented in a digital form. Physical media can be converted into digital media and still contain the essence of the ideas or expression. For example, a photograph, painting, or blueprint, can be scanned and converted into a digital form. A sound recording can be digitized for storage in a digital form.

Any media content in digital form can be converted into a physical form. For example, a digital photograph or digital blueprint can be printed on paper. An audio digital compact disk can be transferred to regular audio tape. Even a digital representation of a sculpture can be recreated physically using robots, milling machines, or lasers.

Media Distribution and Marketing Overhead

Traditionally for media to be transferred from media creators to media users it must be moved through a thick layer of agents, brokers, marketing organizations, distribution channels, middlemen, wholesalers, and retail stores. Each entity along the route adds overhead and takes its piece of the purchase price. For example, a recording artist may only receive a few pennies for every fourteen dollar ($14.00) compact diskette sold after agents, record label, distribution channels, wholesalers, and retailers have all taken a portion of the amount received from the media user.

A system that gives the media creator higher fees while reducing the cost to media users is needed.

Media Databases

Fundamentally a database is a collection data with a system for managing or accessing the data. Various types of databases are known including hierarchical, network, relational, object oriented, and flat file databases. In recent years relational databases have become popular. Examples of relational databases are System R, Ingres, Oracle, Sybase, Progress, Informix, Databean and Pointbase.

A number of database systems have the ability to store large data objects such as digital media and can be referred to as a media database. A combination of a regular file system and any database that references digital media files by file name or other location information can also be used to create a media database. Some media databases can automatically analyze the content of the digital media to create search index information. For example, a picture of an African American officer worker could be analyzed and automatically tagged with the following key words: “woman”, “red dress”, “black”, “African American”, “phone”, “desk”, “computer monitor”, and “books”.

A number of media databases have been built, but access is limited. It is very hard for a media user to find the media that they need at a reasonable price. A system is needed to give media creators and media users world-wide access to media.

Media Rights

Because media together with its content has value, its owners have certain rights. The rights to copy, display, perform, or modify an expression is owned by the creators of the media. The rights to make, use, or sell any media that use a patented idea is granted to the inventor. Information that is kept secret and which has economic value by not being disclosed is protected by tradesecret rights. The ownership of these rights can be transferred to others by selling or licensing the rights. Typically when rights are licensed the owner receives a reasonable royalty for exercise of the rights.

Fundamentally the creator of media retains the rights. However, the rights may be assigned to another by transferring ownership to another person or company who becomes the media rights holder. The media rights holder can license the media rights to others who want to use the media, the media users.

Infringement of Rights

As technology advances, it is easier and easier to copy media that is protected by media owners' rights. For example, the copy machine has made it easier to copy printed text and drawings. The color copier has made it possible to copy color photographs. Today the typical home computer can copy music and videos in digital form. With new analysis tools, equipment, and computer programs, media containing tradesecrets and patented ideas can easily be disassembled, scanned, and reverse engineered.

Because of the ease of piracy and theft of protected media, owners of media rights are forced to limit the distribution of their media and to charge higher license royalties to the honest users of their rights.

What is needed is a system that allows media rights holders to make their media available to the broadest possible audience in such a way that they are easily compensated for the use of their media. Such a system would increase the number of people using the media and would increase the compensations to the media rights holders. When the media rights holder is fairly compensated for the use of the media by a larger number of media users, the average cost of the license can go down. When the cost of each license is low and the license fee is easily negotiated, paid and collected, their incentive to pirate media is diminished.

Project XANADU

For over 40 years, Ted Nelson has been trying to establish a system where copyright holders are properly acknowledged and compensated. The project known as Project XANADU has been fighting, and continues to fight, for a world of deep electronic documents-with side-by-side intercomparison and frictionless re-use of copyrighted material.

The decades old project tries to do too much in a way that has not been successful and has failed to produce the needed result.

Internet

For over 30 years, the Internet has provided a medium for transmitting digital data. The Internet is a world-wide interconnected system of computers and computer networks. The Internet made digital media more easily accessible but by itself has only increased the problem of media piracy. By itself, the Internet has increased the problem rather than solving the problem of fair compensation to media rights holders.

World Wide Web

The World Wide Web, shortened as Web, is an information space within the Internet. Inspired by Ted Nelson's hypertext concept, the Web provides a uniform way to access certain media on the Internet. Web browsers combined with Web search engines and media sharing programs have made it easier for media users to find and take copies of media. The Web by itself has only increased the problem of media piracy. By itself, the Web has increased the problem rather than solving the problem of fair compensation to media rights holders.

Stock Market

A stock market such as the New York Stock Exchange or the NASDAQ provides a model for buyers and sellers to dynamically create a fair market price for a stock. Buyers and sellers through out the world can obtain the current stock price, offer to sell stock they own, or make a bid to buy stock at a certain price. At any moment in time a fair market price is determined by matching the highest bid with the lowest offer. Stock brokers can act as agents of stock buyers and sellers. Stock buyers and sellers can trade directly with each other through an online stock trading system.

The Problems Remains

Despite the advances in database technology, Internet connectivity, and Web access to media, several problems remain. Media creators and media rights holders need a much larger, world-wide, market for what they have. However in giving media rights holders a larger market, their rights to fair compensation for use of their media must be protected and enhanced. Media piracy must be reduced before license fees can be reduced. Media users throughout the world need access to the media that is available, they need to be able to quickly search for what they want, and then they need to easily pay the license fees and easily and quickly obtain access to the media. Media users need and want lower license fees. Overhead in the path between media creators and media users needs to be eliminated to further increase the amounts received by media creators and further decrease the amounts paid by media users. All of these problems can be solved with the present invention.

### SUMMARY OF THE INVENTION

The present invention combines database, Internet, and Web technology with the concepts of the stock market to create a world wide, globally accessible, media exchange wherein media users compensate media rights holders for use of media, and wherein media rights holders are given access to a world wide market of media users. The system and methods of the present invention are known as a “Global Media Exchange.” Additionally, the present invention can be used to create a dynamic fair market price for any media or type of media rights licensing. Additionally, through the use of accounts within the system or through external accounts, such as bank or credit card accounts, media buyers and sellers can easily and automatically purchase and sell rights, and send or receive payments. Alternatively, the exchange can be compensated for providing services including but not limited to storing and hosting, accounting, transaction processing, reporting, printing, copying, receiving, shipping, and tracking for media exchanges.

The present invention also teaches that, in some cases, media creators, media rights holders, and media users may interact with the system through agents or brokers. Some media users may be publishers who obtain the right to use media in publications that each publisher distributes to one or more publication users.

The present invention can store digital media in its media archive. It can also store references to physical media in its database so that prices can be determined and originals and copies can be exchanged.

The present invention also provides a method for ordering physical copies of digital media.

Objects and Advantages

Accordingly, beside the objects and advantages of the method described above, some additional objects and advantages of the present invention are:

1. To provide a computer based exchange for media rights.

2. To provide a global, world-wide market for selling media.

3. To provide a global, world-wide market for licensing media rights.

4. To provide a global, world-wide archive for digital media.

5. To increase the volume and types of media available to media users.

6. To provide a system for determining global fair market values for media and various media rights.

7. To increase the compensation to media creators and media rights holders.

8. To decrease the cost associated with using media.

9. To reduce the overhead in transferring media from media creators to media users.

10. To reduce the size of stored digital media.

11. To reduce the bandwidth required to transmit stored digital media.

12. To provide a system for ordering physical copies of digital media.

13. To provide a system for tracking the transfer of original physical media and physical copies of digital media to media users.

14. To provide a reliable, easy to use storage facility for digital media.

15. To provide an international currency exchange for media rights transactions.

16. To provide a means for publishing a variety of media types.

17. To provide a secure means for sharing media with select media users.

18. To provide a means of maintaining a record of media ownership, namely a title chain.

### DRAWING FIGURES

In the drawings, closely related figures have the same number but different alphabetic suffixes.

FIG. 1A shows an example of a media exchange.

FIG. 1B shows the flow of media through a media exchange.

FIG. 2A shows a flow chart of the method of adding media to an exchange.

FIG. 2B shows a flow chart of the method of retrieving media from a media exchange.

FIG. 3 shows the database structure for an embodiment of a media exchange.

FIG. 4 shows the database structure for another embodiment of a media exchange with purchase accounting.

### REFERENCE NUMERALS IN DRAWINGS

| | |
|---|---|
| 102 | media exchange |
| 104 | use by media creator |
| 106 | media rights holder |
| 108 | media submission |
| 110 | media creator |
| 111 | delegation |
| 112 | agent |
| 114 | indirect submission |
| 116 | individual use |
| 118 | publication use |
| 120 | media user |
| 122 | publisher |
| 124 | published use |
| 126 | another published use |
| 128 | publication user |
| 130 | another publication user |
| 132 | media archive |
| 134 | graphic media |
| 136 | graphic submission |
| 138 | audio media |
| 140 | audio submission |
| 142 | video media |
| 144 | video submission |
| 146 | physical media |
| 148 | physical description |
| 150 | transfer to shipper |
| 152 | shipper |
| 154 | physical delivery |
| 156 | system user |
| 158 | user interface |
| 160 | user's computer |
| 162 | archive interface |
| 164 | rights delivery |
| 166 | duplication order |
| 168 | duplicator |
| 170 | copy creation |
| 200 | submission start |
| 202 | path 202 |
| 204 | create media step |
| 206 | path 206 |
| 208 | physical decision |
| 210 | describe step |
| 212 | physical path 212 |
| 214 | upload and describe step |
| 216 | digital path 216 |
| 218 | set license terms step |
| 220 | path 220 |
| 222 | path 222 |
| 224 | path 224 |
| 226 | submission finish |
| 228 | retrieval start |
| 230 | path 230 |
| 232 | search archive step |
| 234 | path 234 |
| 236 | select item step |
| 238 | path 238 |
| 240 | more decision |
| 242 | more path |
| 244 | no more path |
| 246 | pay fees step |
| 248 | path 248 |
| 250 | receive items step |
| 252 | path 252 |
| 254 | retrieval finish |
| 300 | transaction entity |
| 302 | transaction-bid relationship |
| 304 | transaction-ask relationship |
| 306 | bid entity |
| 308 | bid-ask relationship |
| 310 | bid-bid type relationship |
| 312 | bid-user relationship |
| 314 | ask entity |
| 316 | bid type entity |
| 318 | ask-service type relationship |
| 320 | ask-license type relationship |
| 322 | ask-item relationship |
| 324 | ask-ownership relationship |
| 326 | service type entity |
| 328 | license type entity |
| 330 | description component entity |
| 332 | ownership entity |
| 334 | ownership relationship |
| 336 | description component-phrase |
| | relationship |
| 338 | description-item relationship |
| 340 | ownership-item relationship |
| 342 | ownership-user relationship |
| 344 | ownership-ownership type |
| | relationship |
| 346 | description phrase entity |
| 348 | item entity |
| 350 | ownership type entity |
| 352 | user entity |
| 354 | item-item class relationship |
| 356 | item class entity |
| 358 | user-role relationship |
| 360 | user-organization relationship |
| 362 | organization entity |
| 364 | user-account relationship |
| 366 | role entity |
| 368 | organization-organization type |
| | relationship |
| 370 | organization-state relationship |
| 372 | org type entity |
| 374 | state entity |
| 376 | account |
| 400 | account transaction entity |
| 402 | account-transaction relationship |
| 404 | transaction-invoice item |
| | relationship |
| 406 | transaction-status relationship |
| 408 | transaction-payment relationship |
| 410 | invoice item entity |
| 412 | invoice item-sale item relationship |
| 414 | invoice item-bid relationship |
| 416 | invoice item-user account |
| | relationship |
| 418 | status entity |
| 420 | payment entity |
| 422 | payment-credit card entity |
| 424 | payment-payment method |
| | relationship |
| 426 | payment-invoice relationship |
| 428 | payment-payment status |
| | relationship |
| 430 | bid-sale item relationship |
| 432 | bid-user account relationship |
| 434 | credit card entity |
| 436 | sale item entity |
| 438 | sale item-service type relationship |
| 440 | sale item-sale type relationship |
| 442 | sale item-license type relationship |
| 444 | sale item-media item relationship |
| 446 | sale item-ownership relationship |
| 448 | payment method entity |
| 450 | media description phrase entity |
| 452 | sale type entity |
| 454 | media description phrase- |
| | description phrase relationship |
| 456 | media description phrase-media |
| | item relationship |
| 458 | invoice entity |
| 460 | invoice-user account relationship |
| 462 | invoice-state relationship |
| 464 | invoice-tax relationship |
| 466 | invoice-payment status |
| | relationship |
| 468 | payment status entity |
| 470 | media item-media format |
| | relationship |
| 472 | media item-user account |
| | relationship |
| 474 | user account entity |
| 476 | tax code entity |
| 478 | media format entity |
| 480 | media format-media type |
| | relationship |
| 482 | user account-user role relationship |
| 484 | user account-organization |
| | relationship |
| 486 | user role entity |
| 488 | media type entity |
| 490 | state-country relationship |
| 492 | country entity |
| 494 | configuration entity |

### SPECIAL DEFINITIONS

media—plural of medium, media as used herein broadly refers to a) an intervening substance through which something is transmitted or carried on, b) material or technical means of expression as determined by the materials or creative methods involved, or c) the content of (a) or (b) comprising ideas or expressions that may have associated copyright, patent, or tradesecret rights.

media creator—a person or legal entity that discovers an idea or creates an expression and thereby derives media rights.

media rights holder—a media creator or person or legal entity assigned rights originally held by a media creator.

media user—a person or legal entity who purchases media ownership, who licenses media rights from a media rights holder, or a media pirate.

pirate—a person or legal entity who takes or uses media without properly obtaining media rights.

piracy—making, using, selling, displaying, performing, modifying, disclosing, or distributing media without proper authorization.

publisher—a person or legal entity who obtains rights to use certain media and further distribute copies of that media.

### DESCRIPTION OF THE INVENTION

The present invention combines database, Internet, and Web technology with the concepts of the stock market to create a world wide, globally accessible, media exchange. The media exchange allows media creators and media users to come together to exchange media and media rights. Media creators are able to offer their media for sale in the market. Media creators are also able to license various media rights. Those interested in purchasing all the rights to certain media can do so and become the new media rights holder. The system can provide a simple direct way of compensating media rights holders for use of their media. Thus media rights holders are given access through the media exchange to a world-wide market of media users. The system has the potential to reduce piracy and increase the revenue of media rights holders, allowing them to reduce the fees they charge for various licenses. The reduced fees will induce more media users to license the media that they might not otherwise license. The reduced fees would reduce the incentive to pirate media. The global media exchange will offer a wide selection of various media types and will be much more likely to have the media that media users are looking for.

The recent explosion in the use of the Internet as a daily worldwide communications and information search medium for hundreds of millions of people is one of the most significant advances in the history of the world. It represents a quantum jump in the speed and efficiency with which people find information and communicate.

Digital artists, advertising agencies, business presenters, teachers, students, and home media users need access to a huge media archive that can be searched by classification.

The present invention discloses a media archive containing a comprehensive collection of both stock and fine art, still pictures, clip-art, video, sound effects, sound clips, and music. Copyright holders place their works in the archive and set prices for limited and unlimited, commercial and non-commercial, exclusive and non-exclusive use. Users of the media would agree to a set of terms of use and pay the required fee. The system can be used to collect a license fee and credit the account of the copyright holder. The system of the present invention becomes a clearing-house (auction house) for media. It increases the quality of the media available for its users and creates a digital revolution for the distribution of media and compensation for media creators and media rights holders.

The system could take advantage of compression technology to reduce the space required to store the media and to reduce the cost of distributing copies of the media over the network.

The present invention allows media creators and media rights holders to offer their media to a world-wide market. Digital media can be stored in the media archive. Physical media can be referenced by the media archive. Media rights holders can sell (or assign) their rights or can establish different use categories (single use, unlimited personal use, commercial use, use in a publication such as a print add or web site, etc.) and establish license terms including price for each license option.

The present invention provides a single location where a large collection of media can be searched based on a number of criteria including author, content description, and price. Because of the extent of the collection, a prospective media user is much more likely to find the desired media.

Also, the media user can pay a fair price for the use of the media and the media rights holder can be compensated for each licensed use of his or her creation.

The present invention provides a synergistic community. Artists can be directly and fairly compensated for all use of their creations. Media users know that they can always find something they like and can use at the global media exchange site. The fair compensation and competitive options in a fluid market allows the principles of economics to drive a true market exchange. Like a stock market, the system of the present invention provides a world wide vehicle for establishing the market price for media rights.

Media rights holders can establish an account where sale and license fees can be collected. Media users or buyers can pay for each transaction using a credit card online payment system (such as CyberCash or Intellipay) or establish an account that accumulates charges (possibly against a deposit) and settles the account on a regular basis.

Many content creators are also content users and an embodiment of the global media exchange can maintain the account and handle debits and credits.

In a simpler embodiment, the present invention is merely a digital repository with a mechanism for setting a price. In this exemplary embodiment, payment settlement is handled by the parties and the system of the invention facilitates the distribution process.

The system could also include an interface to a duplication service (a duplicator 168) so that physical copies of digital media could be made and delivered to the media users. This would be useful for photographs, art prints, photo CDs, blue prints, music CDs, DVD videos, etc.

The system is also designed to maintain a record of the chain of title to the media rights. As long as an ownership is being tracked by the system, the original owner would be kept in the system as well as any transactions changing ownership.

The system can be used to verify the proper licensing of any media by a user. Various techniques can be used to digitally mark a piece of media with its owners ID or with a transaction code. Software on the users computer could check for valid license codes or dynamically check with the database over the network, to confirm that a license is still valid. Alternatively, the media could be downloaded in a compressed and encrypted form and only unlocked with the proper code. For a single use license, the code would only work once. In another embodiment, licensed media could report back to the system that it is being used and the system could analyze the data to detect piracy problems.

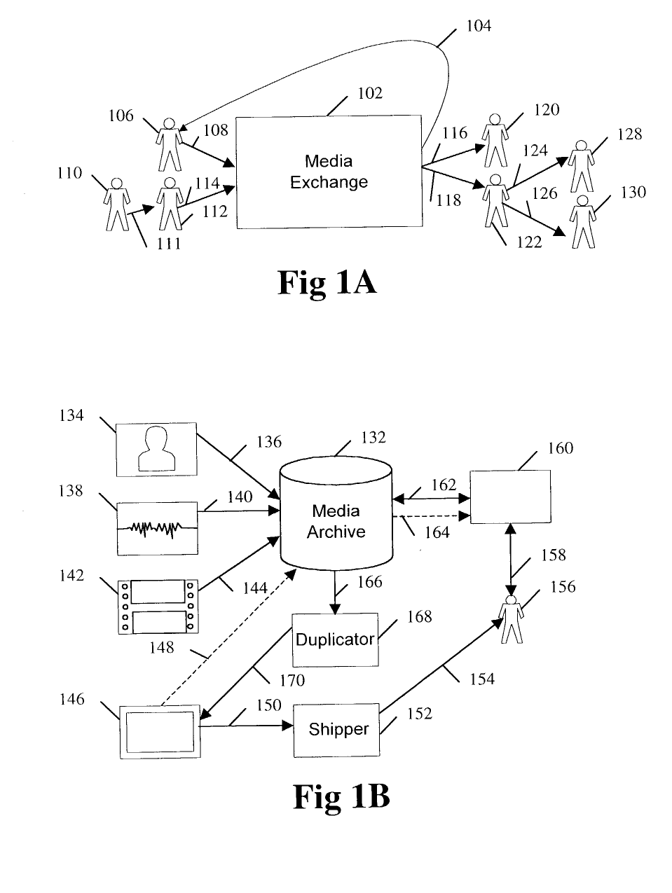

FIG. 1A

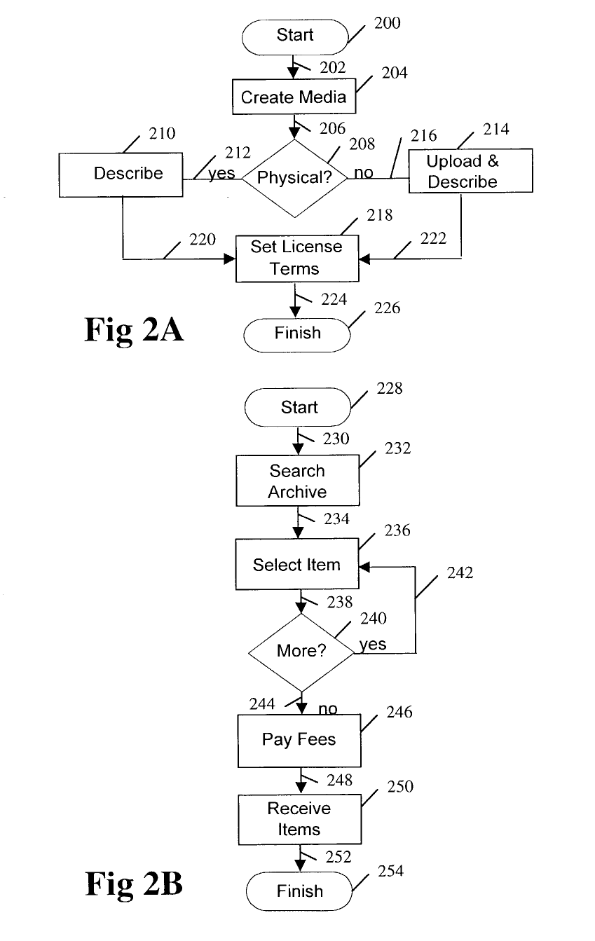

FIG. 1A shows how various people or entities interact with the media exchange 102 of the present invention. A media rights holder 106 can interface directly with the media exchange 102. Direct interaction includes media submission 108, which includes the steps of uploading the media, describing the media, and setting license terms (see description of FIG. 2A). The media rights holder 106 could be a media creator 110 or a purchaser of media and all of the rights associated with it from the media creator 110. The media creator 110 could also go through an agent 112. As shown in FIG. 1A, the media creator 110 can give the media to the agent 112 and authorize the agent 112 to interact with the media exchange 102 through delegation 111. By delegating rights through an agent 112, the media creator 110 uses the media exchange 102 indirectly. In this case, the agent 112 uses indirect submission 114 to interact with the media exchange 102 on behalf of the media creator 110 or the current media rights holder 106. For example, a rock star may delegate the submission of his music, photographs, and music videos to his agent or record label.

A media user 120 may interact with the media exchange 102 to search for desired media. Once a piece of media is selected, the media user 120 can choose from a variety of purchase or license options and can pay a fixed price or bid to create a market price. After a price is determined and the fees are paid and confirmed, the system will allow the media user 120 to receive a copy of the desired media for an individual use 116. For example, a rock fan can download a rock song for personal use. If the media user 120 wants to use a piece of media in a new form that is distributed to another user, the media user 120 acts as a publisher 122. The publisher 122 licenses the media for a publication use 118 and is allowed to further distribute the media to other users. Someone who receives media through such a publication is a publication user 128 and the use is considered a published use 124. The publication user 128 indirectly receives rights to use the media when it is a part of the publication. When another publication user 130 receives the media as part of a publication it is another publication use 126. For example, if a web site designer wants to use a picture of a sunset on a web site, the web site designer can license the media for web publication and viewers of the web site can view the pictures. However the web site viewer cannot legally take a permanent copy of the picture without seeking a proper license. Another example of the publication use 124 is when a compact disk (CD) publisher licenses a rock song for a “Best of the 70's” album on CD, those who receive a copy of the CD are publication users and don't directly receive the media from the media exchange 102. However the media rights holder is compensated through the exchange and having passed through the exchange the media on the CD can be identified as being licensed through a particular publisher.

The media rights holder 106, or the media creator 110, could also be the media user 120 as shown by a “use by media creator” 104. For example, a creator of a collage may use the system of the present invention to obtain a media rights for elements of the collage. Similarly, an item of audio media 138 may be used in a video media 142 creation.

The system of the present invention allows for various types of license, as described above. The media user 120 can obtain a license for unlimited use, time limited use, or single use. In a single use scenario, the media could be streamed using streaming technology, such as Real Networks, Microsoft Windows Media, Apple QuickTime, or my co-pending invention for transmitting video over the Internet. The media exchange 102 would facilitate various license scenarios and download methods.

FIG. 1B

FIG. 1B illustrates the flow of media through, and user interaction with, the media archive 132. A media database serves as the media archive 132. The media archive 132 preferably is an Internet-enabled database repository. The database can either store digital media in the database itself or can reference the media by name or location in a file system or network. The database can also facilitate the exchange of physical media, such as fine art paintings and sculptures, by describing the physical media, by providing a market for exchange of ownership and rights, and by facilitating the shipment of physical media.

FIG. 1B shows three examples of different types of digital media: 1) a graphic media 134 could be a digital photograph, digital artwork, scanned image, digital blue print, schematic or similar graphic image; 2) the audio media 138 could be any type of digital sound recording, including music, sound effects, vocals, voice recordings or similar audio recording; and 3) the video media 142 could be computer animations, digital video, digitized video, or other video containing moving pictures and associated sound tracks. The digital media is transferred to the media archive 132 via a graphic submission 136, an audio submission 140, or a video submission 144, respectively. After digital media is submitted a digital copy is maintained in the media archive 132.

The media archive 132 could be comprised of one or more computer systems that provide digital media storage, information storage in a database, programs that generate forms and process responses, and a network interface to a users computer. The network interface preferably is an Internet connection and a Web server.

The media archive 132 may prepare preview copies of media that are also stored in the archive. Preview copies may be smaller, lower resolution image “thumbnails” of graphics, or short clips of video or audio. The graphic, audio, or video may also be distorted with a watermark or filter so the preview copy is not likely to be pirated.

At the same time the media is submitted, the media rights holder 106 is a system user 156 who interacts with the system to describe the media and set purchase and license terms. Any system user 156, whether the media creator 110, the media rights holder 106, the agent 112, the media user 120, or the publisher 122, uses a user interface 158 on a user's computer 160 to interact with an archive interface 162. The user interface 158 displays various forms for the system user 156 to fill out when interacting with the system.

The forms are preferably Web pages generated by the media archive 132. Good results have been obtained by using the Oracle database and using Java and PL/SQL statements to generate and process the forms. Other means for generating web pages in conjunction with a database are known in the art and include Microsoft SQL/Server, active server pages (ASP) with ODBC, java server pages (JSP) with JDBC, pern scripts with ora-perl or ODBC, Cold Fusion, and hundreds of similar combinations.

FIG. 1B also shows a physical media 146 being included in the media archive 132 through a physical description 148. Examples of physical media include oil paintings, sculptures, charcoal drawings, audio tapes, compact diskettes, motion picture film, photographs, photographic negatives, hand drawn blue prints, memorabilia, or similar physical pieces of media. Physical media could also include copies of digital media that are created by a duplicator 168. The physical media 146 cannot itself be stored digitally in the media archive 132, so only a reference (via a physical description 148) is stored in the database of the media archive 132. The system of the present invention allows for media rights holders to offer the physical media 146 in the media exchange 102 via database information in the media archive 132 in a similar way that digital media is offered. The system can be used to set fixed prices or to determine a dynamic fair market value through bids. Because physical media cannot be received digitally through the archive interface 162, only information representing a rights delivery 164 is sent to the user's computer 160.

Additionally, the system of the present invention allows for the system user 156 to purchase a license to copy digital media into a physical form and to order a physical copy of the digital media. A duplication order 166 is sent to the duplicator 168, which creates a piece of the physical media 146 via a copy creation 170. Along with the duplication order 166 is information necessary to transfer the media to a shipper 152 (as shown by a transfer to shipper 150). Examples of duplicators are black and white or color printers, photographic printers, poster printers, tape recorders, CD burners, film printers, milling machines, laser cutters, and robotic devices capable of make physical copies based on media data stored in the database. Examples of shippers are the U.S. Postal Service, FedEx, UPS, DHL, bicycle couriers, delivery vans, moving companies, or similar entities that can pickup, transport, and deliver physical media. The systems user 156 (in this case the media user 120) receives the physical media 146 from the shipper 152 as a physical delivery 154.

FIG. 2A

FIG. 2A shows a flow chart for an embodiment of a submission method of the present invention. The chart begins at an entry point or a submission start 200, continues along a path 202 to a “create media” step 204. Flow continues along a path 206 to a “physical” decision 208. If the “physical” decision 208 is “yes” then flow continues along a physical path 212 to a “describe” step 210 where the system user 156 describes the physical media 146. Flow continues, along a path 220, to a “set license terms” step 218 where the system user 156 sets up one or more options for purchasing or licensing the media. Flow continues along a path 224 to a submission finish step 226.

However, if the “physical” decision 208 is “no”, flow continues along a path 216 to an “upload and describe” step 214 where a copy of the digital media is transferred to the media archive 132 and the media is described. Flow continues along a path 222 to the “set license terms” step 218, then along the path 224 and ends at a submission finish 226.

FIG. 2A

FIG. 2B shows a flow chart for an embodiment of a retrieval method of the present invention. The chart begins at a retrieval start 228, continues along a path 230 to a “search archive” step 232 where the system user 156 enters search criteria and conducts searches until a list of matching media items are found. Flow continues along a path 234 to a “select item” step 236 where a media item is selected. The flow continues along a path 238 to a “more” decision 240. If there is more, then the flow continues along a more path 242 back to the “select item” step 236. This process continues until the user does not want to select any more items. When the more decision 240 is “no”, then flow continues along a “no more” path 244 and then reaches a “pay fees” step 246 where fees are paid and confirmed. After the “pay fees” step 246, flow continues along a path 248, hits a “receive items” step 250, where the media, associated rights, and, in some cases, the codes to unlock those rights are received. If the media is digital, a copy is transferred to the user. If the media is physical, an order to ship the media is issued to the shipper 152. Then flow continues along a path 252. The flow stops at a retrieval finish 254.

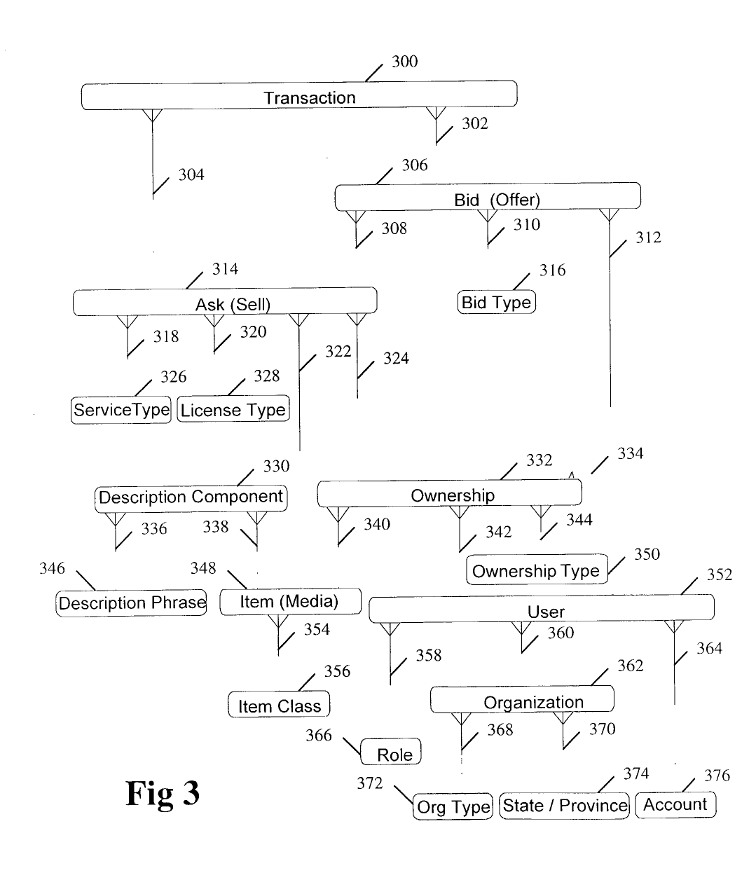

FIG. 3

FIG. 3 shows a simple database model for an embodiment of the present invention where the system provides for establishing a market price and transferring rights, but does not support the actual money transfer and accounting. This diagram is known as an entity-relationship model and is used by those skilled in the art to understand the details of a database design. Some of the entities shown are a user entity 352 and a role entity 358. The user entity contains database information about each system user 156. A role entity 366 contains database information about each role a user can have. For example the system user 156 could have any of the following roles: media creator 110, media rights holder 106, agent 112, media user 120, or publisher 122. The user-role relationship, in this case, shows that one or more users could have the same role.

The details of these entities and relationships in this embodiment are similar to those defined in detail by the “Global Media Archive Design Document” attached as Appendix A. There certainly would be substantial differences at that level of detail. However, at the level that is taught and claimed by the present invention, the essence of the invention is the same, and one skilled in the art would be able to discern the necessary details and implement an embodiment of the invention without undue experimentation.

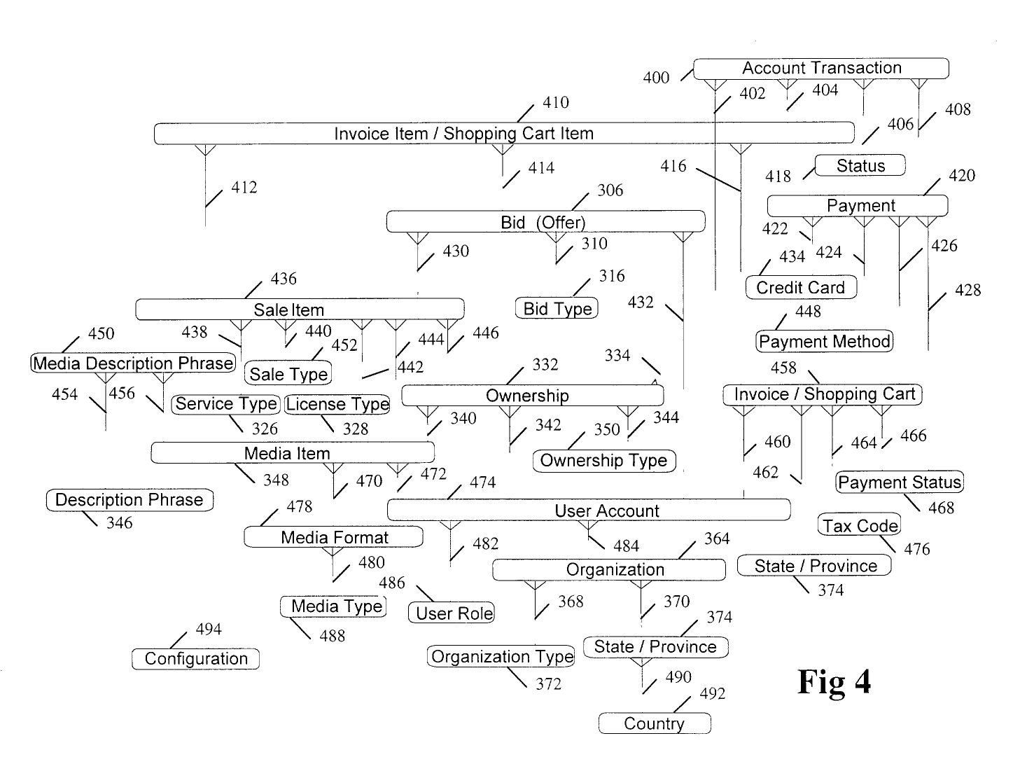

FIG. 4

FIG. 4 shows a more complex database model for an embodiment of the present invention where the system provides for establishing a market price and transferring rights, and also supports the actual money transfer and accounting. This diagram is also an entity-relationship model and is used by those skilled in the art to understand the details of this similar but different database design. Some of the additional entities shown are a payment entity 420 and a credit card entity 434. The details of each entity and relationship are described in detail in the “Global Media Archive Design Document” attached as Appendix A, and is hereby incorporated as a part of this specification.

Another complex database model has been developed for the Global Media Exchange. The details of its design, including its entity relationship model, is attached in Appendix B, entitled “Global Media Exchange (GMX) Design Document”, and is hereby incorporated as part of this specification.

It can be seen from these various designs that each design encompasses the scope of the present invention; various embodiments of the invention can have different implementations but still fall under the scope and spirit of the present invention.

Sample Forms—Appendix C

Appedix C shows examples of user interface 158 forms of an embodiment of the present inventions. Appendix C is also hereby incorporated as part of this specification. In Appendix C, C1 through C22 show examples of user interface 158 forms for an exemplary embodiment media exchange 102. The forms are not necessarily in the order in which they would appear when using the system.

Conclusion, Ramification, and Scope

Accordingly, the reader will see that the present invention provides a system and methods of creating a globally accessible media exchange, where media creators, media rights holders, and agents can offer media and media rights to a world-wide market. Media users and publishers can find and preview the media that they need or want and purchase media ownership or license media rights through the exchange. The media exchange can handle both digital media, such as digital graphics, digital audio, or digital video, and physical media. The media exchange can be used to establish a dynamic fair market value for each type of media ownership or license.

While my above descriptions contain several specifics, including details of a few implementations of the invention, these should not be construed as limitations on the scope of the invention, but rather as examples of some of the preferred embodiments thereof. Many other variations are possible. For example, other embodiments which are implemented on networks other than the Internet or which use standalone software on a user's computer instead of a Web browser and Web pages would also fall within the scope of the present invention.

Accordingly, the scope of the invention should be determined not by the embodiments illustrated, but by the appended claims and their legal equivalents.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. A system for exchanging media and associated media rights,
wherein a media creator can submit a created item of media to a market consisting of a plurality of media users, and,
wherein each media user can search for a desired item of media within a plurality of created items of media, and
wherein a price for the desired item of media can be determined,
whereby each media user can pay said price for the desired item of media, and
whereby each media creator can receive said price for the desired item of media, and,
whereby the media user can receive the desired item of media.

2. The system of claim 1 wherein the media creator delegates interaction with the exchange to an agent who submits the created item of media on behalf of the media creator.

3. The system of claim 1 wherein the media creator delegates interaction with the exchange to an agent who dynamically accepts bids to determine a fair market price.

4. The system of claim 1 wherein a software program within the media exchange automatically matches lowest asking prices with highest bids to determine a fair market price as said price for the desired item of media.

5. The system of claim 1 wherein a media user is a publisher who purchases rights to distribute said desired item of media in a publication to one or more publication users.

6. The system of claim 1 wherein the created media is digital graphic media.

7. The system of claim 1 wherein the created media is digital audio media.

8. The system of claim 1 wherein the created media is digital video media.

9. The system of claim 1 wherein the created media is physical media.

10. The system of claim 1 where said media user issues a duplication order, whereby an item of digital media is copied into a item of physical media.

11. The system of claim 1 where said media user issues a shipment order,
whereby an item of digital media is transferred to said media user.

12. A system for exchanging media and associated media rights, comprising:
(a) A media archive comprising:
(b) a media database,
(c) a computer program for generating user forms and interacting with the media database,
(d) a network connection from the media archive to a user's computer
(e) a user interface for displaying said user forms and receiving input from a system user,
whereby one of a plurality of system users, a first system user, can submit an item of created media to the media archive, and
whereby another one of a plurality of system users, a second system user, can locate a desired item from a plurality of items of created media and determine a price for said desired item.

13. The system of claim 12 further comprising a duplicator whereby said system receives a duplication order from a system user and responds by creating an item of physical media corresponding to said desired item.

14. The system of claim 12 further comprising a shipper whereby said system receives a shipment order from a system user and responds by transferring an item of physical media corresponding to said shipment order.

15. The system of claim 12 wherein said first system user can set the price for said desired item.

16. The system of claim 12 wherein said second system user can dynamically bid for desired item, and
wherein said first system user can accept a bid,
whereby said price for the desired item is determined.

17. The system of claim 12 wherein a plurality of system users can dynamically bid for said desired item, and
wherein one or more system users can dynamically offer to sell rights for said desired item,
whereby said price for the desired item is automatically determined by said computer program by comparing said bids and said offers.

18. A method for submitting media to a media exchange comprising the steps of:
(a) creating an item of media,
(b) submitting said item of media to a media archive,
(c) setting terms for the purchase of rights for said item of media,

19. The method of claim 18 further comprising the step of
(d) updating the asking price for said item of media.

20. A method for retrieving media from a media exchange comprising the steps of:
(a) searching a media archive for a desired item of media,
(b) selecting certain rights for said desired item of media,
(c) determining a price for said rights,
(d) paying said price,
(e) receiving said desired item of media.

21. The method of claim 20 wherein the step of determining the price for said rights includes submitting one or more bids and waiting for one of said bids to be accepted.

22. The method of claim 20 wherein said desired item of media is received as digital media.

23. The method of claim 21 wherein said digital media licensed for one time use and is received via a streaming technology.

24. The method of claim 20 wherein said desired item of media is received as physical media.

25. A system for transferring digital media over a network comprising:
(a) a media archive for storing and transmitting said digital media,
(b) a user's computer for receiving said digital media,
(c) said network connecting said media archive to said user's computer, whereby a system user can
(a) select a desired item of digital media,
(b) determine a price of said desired item of digital media,
(c) pay said price, and
(d) receive said desired item of digital media.

26. The system of claim 25 wherein said price is determined based on dynamic bidding.

27. The system of claim 25 wherein said digital media is video media.

28. The system of claim 25 wherein said digital media is audio media.

29. The system of claim 25 wherein said digital media is graphic media.

30. The system of claim 25 wherein said digital media is stored in a compressed formatted in said media archive.

31. The system of claim 25 wherein said digital media is transferred in a compressed format over said network.

32. The system of claim 25 wherein said digital media is decompressed on the user's computer.

33. The system of claim 32 wherein a code from the media archive is required to unlock the compressed digital media on the user's computer,
whereby said digital media can only be used by a system user who has received the code associated with certain media rights.

34. An article of manufacture comprising physical media created by a duplicator using digital media stored in a media archive, wherein a system user issued a duplication order through said media archive.
